(19) United States
(12) Patent Application Publication
(10) Pub. No.: US 2026/0359390 A1
(43) Pub. Date: Nov. 12, 2026

(54) METHODS AND SYSTEMS OF ARITHMETIC OPERATIONS OF REAL NUMBERS REPRESENTED IN AN ALGEBRAIC INTEGER FORMAT

(71) Applicant: LEMURIAN LABS INC., Toronto (CA)

(72) Inventors: Vassil DIMITROV, Calgary (CA); Anthony KOSTAL-VAZQUEZ, Calgary (CA)

(73) Assignee: LEMURIAN LABS INC., Toronto, ON (CA)

(21) Appl. No.: 19/667,873

(22) Filed: May 5, 2026

Related U.S. Application Data
(60) Provisional application No. 63/800,827, filed on May 6, 2025.

(51) Int. Cl. G06F 17/17; G06F 17/16

(52) U.S. Cl. CPC G06F 17/17; G06F 17/16

(57) ABSTRACT

A computer implemented method of arithmetic operations of real numbers represented in an algebraic integer format includes approximating a first real number X in the format of: a+(b*β). A second real number Y is approximated in the format of: c+(d*β). Wherein, a, b, c and d are integers. β is an irrational number approximated as a rational number to a predetermined degree of accuracy. Additionally, β is an algebraic integer defined as a real number that is a root of a monic polynomial with integer coefficients, wherein the leading coefficient of the monic polynomial is equal to 1.

### CROSS REFERENCE TO RELATED APPLICATIONS

This application is a non-provisional application of, and claims the benefit of the filing date of, U.S. provisional application 63/800,827, filed May 6, 2025, entitled: “METHODS AND SYSTEMS OF ARITHMETIC OPERATIONS OF REAL NUMBERS REPRESENTED IN AN ALGEBRAIC INTEGER FORMAT.” The contents of the aforementioned application is incorporated herein by reference in its entirety.

### TECHNICAL FIELD

The present disclosure relates to methods and systems of arithmetic operations of real numbers represented in an algebraic integer format. More specifically, the disclosure relates to computer implemented methods and systems of arithmetic operations of real numbers represented in an algebraic integer format, used to quantize and manipulate weights and activations in large scale neural network models.

### BACKGROUND

In order to reduce the extremely large size of many machine learning or artificial intelligence models, it is essential to quantize the weights and activations of the associate neural networks as accurately as possible with as few as possible bits. Such neural networks are often modeled as many layers of large tensors (e.g., multidimensional arrays of numbers that represent data), that can contain on the order of, for example, 8 billion to 671 billion parameters or more.

In neural networks, “weights” are the parameters (real number values) that determine how much influence each input has on the output. “Activations,” in neural networks typically refer to the output of a neuron after an activation function has been applied to the neuron's weighted sum of inputs. “Quantization of weights and activations” refers to reducing the precision of the numerical values (weight and activations) used in a neural network model, often from 32 bit floating-point to lower-precision (for example 8 bit) integers, to shrink model size and speed up inference and training.

Problematically, even though quantization can reduce model size and increase inference speed, quantization of a model can result in a loss of accuracy.

Several prior data formats have been used to quantize the weights and activations of large neural networks in the past. For example, conventional binary formats or various logarithmic formats. However, these formats might produce impressive reduction in size, the corresponding arithmetic operations on the quantized weights and activations can become complex, time consuming, costly and include approximations that further reduce the accuracy of the inferences.

Accordingly, there is a need for a data format, which represents the numerical values of a model's weights and activations very accurately with as few bits as possible. There is also a need for a data format that provides fast and error free arithmetic on the quantized values, such as, for example, in matrix multiplication.

### BRIEF DESCRIPTION OF THE INVENTION

The present disclosure offers advantages and alternatives over the prior art by providing a data format, which enables much more flexible and precise representation of the weights and activations in a neural network than previous prior art data formats. The data format also eliminates the need to use floating point arithmetic, or the use of a bit for the sign, in the computations of large matrix multiplications. Advantageously, the data format enables error-free execution of the entire computational process. Further, the illumination of floating point operations leads to massive reduction of the energy cost of those computations and the use of purely integer-based computations eliminates the role of the rounding off errors.

A computer implemented method of arithmetic operations of real numbers represented in an algebraic integer format in accordance with one or more aspects of the present disclosure includes approximating a first real number X in the format of: a+(b*β). A second real number Y is approximated in the format of: c+(d*β). Wherein, a, b, c and d are integers. β is an irrational number approximated as a rational number to a predetermined degree of accuracy. Additionally, β is an algebraic integer defined as a real number that is a root of a monic polynomial with integer coefficients, wherein the leading coefficient of the monic polynomial is equal to 1.

In some embodiments of the method, β is an algebraic integer of degree two, wherein β is the root of a monic polynomial of the form (β²)−(p*β)−q=0, and wherein p and q are integers.

In some embodiments of the method, algebraic integer addition of X plus Y is derived as X+Y=(a+b*β)+(c+d*β)=(a+c)+((b+d)*β).

In some embodiments of the method, algebraic integer multiplication of X time Y is derived as X*Y=((a*c)+(q*b*d))+((a*d)+(b*c)+(p*b*d))*β.

In some embodiments of the method, the first real number X is a first real number component of a first vector X[j] comprised of j=1 to n first real number components. The second real number Y is a second real number component of a second vector X[j] comprised of j=1 to n second real number components. From j=1 to n, each first real number component of the first vector X[j] is approximated in the format of a[j]+(b[j]*β). From j=1 to n, each second real number component of the second vector Y[j] is approximated in the format of c[j]+(d[j]*β). A dot product (X[j] dot Y[j]) of the vectors X[j] and Y[j] is calculated by multiplying, from j=1 to n, each corresponding first real number component and second real number component via the multiplication formula of: X[j] *Y[j]=((a[j] *c[j])+(q*b[j] *d[j]))+((a[j] *d[j])+(b[j] *c[j])+ (p*b[j] *d[j]))*β, to obtain the products of (e[j]+f[j] *β, wherein:
e[j] equals ((a[j] *c[j])+(q*b[j] *d[j])), and
f[j] equals ((a[j] *d[j])+(b[j] *c[j])+(p*b[j] *d[j]).
   Thereafter, summing, from j=1 to n, each product of e[j]+f[j] *β to obtain the dot product (X[j] dot Y[j]) in an algebraic integer format. The dot product (X[j] dot Y[j]) is then converted to a binary format.

In come embodiments of the method the first vector X[j] is a row of a first matrix, and the second vector Y[j] is a column of a second matrix.

Another computer implemented method of arithmetic operations of real numbers represented in an algebraic integer format in accordance with one or more aspects of the present disclosure includes approximating a first real number X in the format of: a+(b*β). A second real number Y is approximated in the format of: c+(d*β). Wherein, a, b, c and d are integers, β is an irrational number approximated as a rational number to a predetermined degree of accuracy of 4 bits or greater. β is also an algebraic integer of degree two defined as a real number that is a root of a monic polynomial of the form (β²)−(p*β)−q=0, and wherein p and q are integers.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits and advantages described herein.

### BRIEF DESCRIPTION OF THE DRAWINGS

The disclosure will be more fully understood from the following detailed description taken in conjunction with the accompanying drawings, in which:

FIG. 1, depicts an example of a computer-implemented method of addition of real numbers represented in an algebraic integer format, according to aspects described herein;

FIG. 2, depicts an example of a computer-implemented method of multiplication of real numbers represented in an algebraic integer format, according to aspects described herein;

FIG. 3, depicts an example of a computer-implemented method of calculating a dot-product of two vectors represented in an algebraic integer format, according to aspects described herein; and

FIG. 4 depicts an example of a computing environment useable to perform the methods of FIG. 1, FIG. 2 and FIG. 3, according to aspects described herein.

### DETAILED DESCRIPTION

Certain examples will now be described to provide an overall understanding of the principles of the structure, function, manufacture, and use of the methods, systems, and devices disclosed herein. One or more examples are illustrated in the accompanying drawings. Those skilled in the art will understand that the methods, systems, and devices specifically described herein and illustrated in the accompanying drawings are non-limiting examples and that the scope of the present disclosure is defined solely by the claims. The features illustrated or described in connection with one example may be combined with the features of other examples. Such modifications and variations are intended to be included within the scope of the present disclosure.

The terms “significantly”, “substantially”, “approximately”, “about”, “relatively,” or other such similar terms that may be used throughout this disclosure, including the claims, are used to describe and account for small fluctuations, such as due to variations in processing from a reference or parameter. Such small fluctuations include a zero fluctuation from the reference or parameter as well. For example, they can refer to less than or equal to +10%, such as less than or equal to +5%, such as less than or equal to +2%, such as less than or equal to +1%, such as less than or equal to +0.5%, such as less than or equal to +0.2%, such as less than or equal to +0.1%, such as less than or equal to +0.05%.

### Mathematical Basics and Examples:

### Definition of “Algebraic Integer”:

As used herein, the definition of “Algebraic Integer” is a real number that is a root of a monic polynomial with integer coefficients. (“Monic” means that the leading coefficient of this polynomial is equal to 1).

### Examples

1. The golden ratio, phi=(1+√(5))/2 is an algebraic integer, since it is a root of the polynomial x²−x−1=0.
2. The number x=√(2)+√(3) is an algebraic integer, since it is a root of the polynomial x⁴−10*x²+1=0
3. Number pi is not an algebraic integer, since it is not a root of any polynomial with integer coefficients.

### Density Theorem:

The most important—in terms of quantization-theorem is the following Density Theorem:
If β is an irrational number, then the set of real numbers of the form (a+b*B), wherein a and b are integers, is dense over the real line.

The term ‘dense’ means that in any interval on the real line, however small, one can find infinitely many numbers that can be written exactly in the form a+b*B, wherein a and b are integers. As used herein and in the accompanying FIGS., the expression “B” may also be referred to as “beta.”

The essence of this theorem is that it provides a mathematical guarantee that any real number X can be approximated with any desired precision in the algebraic integer format of:

(a+b*β),(a,b)—integers.

So, the integer pair—(a, b)—can be considered as an additional/optional short form encoded format of X represented in the algebraic integer format of X=a+b*β.

### Derivation of Arithmetic Operations:

If β is an algebraic integer of degree two, that is, β is a root of a polynomial of the form: β²−p*−q=0, wherein p and q are integers (Equation 1), then the arithmetic operations of algebraic integer addition and algebraic integer multiplication between any two real numbers X and Y represented in an algebraic integer format can be derived and defined as follows:

Let X=a+b*β.

Let Y=c+d*β.

Then:

Algebraic Integer Addition (AIA) of real numbers: X+Y:

X+Y=(a+b*β)+(c+d*β)=(a+c)+(b+d)*β (Equation 2).

The above equation may be re-written in short form encoded format as follows:

X+Y=(a,b)+(c,d)=(a+c,b+d).

Algebraic Integer Multiplication (AIM) of real numbers X*Y:

X*Y=(a+b*β)*(c+d*β)=ac+ad*β+bc*β+bd*β² (Equation 3).

However, from Equation 1 above, it is known that:

β²−p*β−q=0,

Therefore, solving for β², one gets:

β²−p*β+q (Equation 4).

Accordingly, substituting for β² in Equation 3, one gets:

ac+ad*β+bc*β+bd*(p*β+q)=

ac+ad*β+bc*β+bdp*β+bdq=

Therefore, regrouping the elements of the above equation, one gets:

X*Y=(ac+bdq)+(ad+bc+bdp)*β (Equation 5).

The above Equation 5 is the product of X*Y expressed in algebraic integer format. Equation 5 may also be expressed in the shortened encoded format as follows:

X*Y=(a,b)*(c,d)=(ac+bdq,ad+bc+bdp)

### Technology Improvement Over the Prior Art:

Advantageously and importantly, the two mathematical operations—AIA (i.e., Equation 2) and AIM (i.e., Equation 5)—are exact. Therefore, they represent a significant technological improvement over the prior art in the computer technology field and more specifically in the field of quantization of weights and activations in neural networks. This is because there is NO accumulation of rounding-off errors.

The encoding of each pair X and Y corresponds to a real number with infinite precision of accuracy. The only approximation made during encoding to an algebraic integer is when the irrational number “B” is approximated as a real number, which, by virtue of the earlier introduced Density Theorem, can be made to any degree of precision required or desired. Once encoded, the output of the arithmetic operations AIA and AIM are error-free. This important feature allows one to execute the dot-products (used throughout matrix multiplication) without accumulating errors and, therefore, ensuring that the output is error-free. The only error that will occur will be associated with the conversion from the algebraic integer to floating point format at the end of the arithmetic operation. The conversion cost is one multiplication by a fixed constant and one floating point addition. For example, if one uses algebraic integers of the form a+b*√(2) (wherein β=2^{0.5}), then an approximation of √(2) as 181/128 will ensure that the final result will be correct with at least 12 bits of precision. If this precision is insufficient, one can use more accurate approximations of the main parameter, √(2), to ensure the accuracy of the computations with any prescribed precision.

Examples of Dot-product engine based on encoding algebraic integers:

In the following examples, the following conditions apply:
1. β equal the square root of 2 (i.e., β=2^{0.5});
2. p equals 0;
3. q equals 2; and
4. the monic polynomial of which β is a root is: β²−2=0

Note, however, that any number of other values of β and other monic polynomial equations may also be used to represent real numbers X and Y, and/or real number components of vectors X[j], Y[j]. By way of example, β may equal (1−5^{0.5})/2 or (1+5^{0.5})/2, since these two values are the roots of the monic polynomial of β²−β−1=0, wherein p equals 1 and q equals 1.

If one wanted to compute the dot product of two vectors (X[j], j=1 to n and Y[j], j=1 to n) of a set of real number components with algebraic integer quantization, the general algorithm for this looks like:

Step 1: approximate every real number component of those vectors, as a pair of integers as follows:
X[j]=(a[j]+b[j] *β) in algebraic integer format, or X[j]=(a[j], b[j]) in encoded format.
Y[j]=(c[j]+d[j] *β) in algebraic integer format, or Y[j]=(c[j], d[j]) in encoded format.
for every j=1 to n.

Step 2: Execute the dot product by making us of the above multiplication (Equation 5) and addition (Equation 2) rules. (Note for purposes of brevity, the following will be carried out in the shortened encoded format):

X[j]*Y[j]=(a[j],b[j])*(c[j],d[j])=(a[j]*c[j]+b[j]*d[j]*q),(a[j]*d[j]+b[j]*c[j]+b[j]*d[j]*p)

Since, in these examples, q=2 and p=0, the above equation may be re-written as:
(a[j] *c[j]+2*b[j] *d[j]), (a[j] *d[j]+b[j] *c[j])=
to obtain the products of e[j], f[j], wherein e[j]=(a[j] *c[j]+2*b[j] *d[j]), and f[j]=(a[j] *d[j]+b[j] *c[j])
for every j=1 to n.

Step 3: Thereafter summing, from j=1 to n, each product of e[j]+f[j] *2^{0.5} to obtain the dot product (X[j] dot Y[j]) in an algebraic integer format.

Step 4: Convert the dot product in algebraic integer format to binary format.

Examples of Matrix-multiplication engine based on encoding algebraic integers:

If one want to compute the product of two matrices, X(nxn) and Y(nxn), with elements (x[i,j] and y[i,j])—real numbers with algebraic integer quantization, the general algorithm for this looks like:

Step 1: Approximate every real component of those matrices, as a pair of integers:

x[i,j]->(a[i,j],b[i,j])

y[i,j]->(c[i,j],d[i,j])
for i=1 to n and j=1 to n

Step 2: Execute the matrix multiplication as a succession of dot products by making use of the multiplication and addition rules:

(a[i,j],b[i,j])*(c[i,j],d[j])=(a[i,j]*c[i,j]+2*b[i,j]*d[i,j],a[i,j]*d[i,j]+b[i,j]*c[i,j])

and

(a[i,j],b[i,j])+(c[i,j],d[i,j])=(a[i,j]+c[i,j],b[i,j]+d[i,j])
for i=1 to n and j=1 to n.

Step 3: For every output obtained, (e[j], f[j]), perform the final reconstruction step like this:

z[i,j]=e[i,j]+g[i,j]*√(2)

for i=1 to n and j=1 to n

### Complexity Analysis:

Assuming that one uses k-bit integers to quantize the input data and the size of the matrices is nxn. So, the complexity will be estimated as a function of those two parameters: k and n.

Step 1—the quantization-requires O(k*n²) comparison operations with the use of a Look Up Table (LUT) algorithm as described in the article titled: “Algebraic Integer Quantization and Conversion”, MITRE Technical Report AD-A206 664, by S. O'Neil et al. dated 1988, which is incorporated herein in its entirety.

Step 2—the matrix multiplication-requires O(n³) arithmetic operations

Step 3—reconstruction-requires O(n²) arithmetic operations.

The overall complexity budget is O(n³+k*n²) operations. Since in all target applications the condition k<<n is satisfied, the complexity of the procedure is O(n³)

### Table I: Pictorial Representation of Different Data Formats:

The pictorial representation of different numerical data formats reveals the main advantage of the algebraic-integer encoding-which is that only two fields (e.g-two integers) are used to work with all real numbers that occur in the computation of matrix multiplications.

### Floating Point:

| | | |
|---|---|---|
| Sign | Mantissa | Exponent |

### Posits:

| | | | |
|---|---|---|---|
| Sign | Mantissa | Regime bits | Exponent |

### Logarithmic Number System (LNS)

| | | | |
|---|---|---|---|
| Sign of the | Sign of the | Mantissa of the | Exponent of the |
| number | exponent | exponent | exponent |

### PAL

(As described in PCT Patent Application PCT/IB2024/055704, Publication No. WO2025/052320, International Filing Date of Sep. 6, 2024, which is herein incorporated by reference in its entirety.)

| | | |
|---|---|---|
| Sign | Exponent1 | Exponent2 |

### Algebraic-Integer Format

| | |
|---|---|
| Real-part-1 | Real-part-2 |

Advantageously the Algebraic Integer Format only uses two-fields. Additionally, there is no need to waste space for the sign bit. In the case of 32 or 64-bit data formats the elimination of the sign bit may be that significant. However, in lower precision quantization of activations and weights wherein only 4 to 8 bits are used, the elimination of the sign bit is much more significant.

### Zero:

In all of the above prior art data formats, of Table I, the encoding of zero relatively complex compared to the Algebraic Integer Data Format. In the case of LNS and PAL, there is no zero at all, so one has to allocate a special bit for zero. However, in the case of the Algebraic-Integer Data Format, the encoding of zero is just . . . (0,0)! Moreover, the encoding of zero is EXACT. It is not an approximation.

### The Significance of the Sign:

When a real number X is represented as a pair of integers, (a, b), and a real number Y is represented as another pair of integers (c, d) in an algebraic integer format, the sign of the numbers may be determined as follows:
1. sign of X is +1 if a+b*β is greater than 0, otherwise sign of X is −1; and
2. sign of Y is +1 if c+d*β is greater than 0, otherwise sign of Y is −1.

By way of example:
If a pair of integers (a, b) encodes to the real number r→a+b\sqrt{2}

The sign of r is determined as follows:
Sign(r)=+1 if a+b\sqrt{2}>0, otherwise, Sign(r)=−1

By way of another example, the sign of the following encoded number (7,−5) can be found as follows:
7−5\sqrt{2}=−0.0710678 . . . .

Accordingly, (7,−5) corresponds to a negative number.

### Sign-Less DATA Format:

The Algebraic Integer Data Format, is believed to be the first data format that does not use a special bit for the sign. It does not mean that one works with unsigned numbers. Rather, one simply does not waste bit-space for the sign. When the sign is needed, it can be recover with a single multiplication by a constant and an addition. Since the matrix multiplication does not require any checks of the signs of the numbers involved, it is advantageous to use such a data format. Moreover, use of the algebraic integer format is advantageously EXACT in terms of both addition and multiplication! So, the only approximation is the one associated with the quantization, i.e., the approximation of β.

Another example of dot-product computation with algebraic integers.

Consider the dot product of the two vectors:

v₁={0.242,−0.344,0.627,0.041}

and

v₂={0.657,0.787,−0.213,0.444}4

The real numbers used in this example can be approximated with algebraic integers of the form a+b\sqrt{2} like this:

v₁=>{(−4,3),(−6,4),(−22,16),(−24,17)}

and

v₂>{(−5,4),(22,−15),(21,−15),(16,−11)}

By applying the above EXACT rules for multiplication and addition we get:

v₁*v₂=(−4,3)*(−5,4)+(−6,4)*(22,−15)+(−22,16)*(21,−15)+(−24,17)*(16,−11)=(44,−31)+(−252,178)+(−942,666)+(−758,536)=(−1908,1349)

This example reveals one of the main features of the algebraic-integer encoding: after the initial approximation, the remaining steps of the computation of the inner products are completely error-free! It is certainly beneficial to have only ONE source of error-namely, the one associated with the quantization.

### Experimental Results:

As background, one of the best open source large language models (LLMs) is called Llama-3.1-8B-Instruct by meta (formerly facebook). A large language model is an AI model that can comprehend and generate human language. Some popular examples include metas llama models, chat-gpt and googles gemini model. To use these models all one needs to do is ask the LLM a question and it will generate a response.

For the experiment, one must consider how one can measure an LLMs performance. This is a huge body of ongoing research but as of today LLM's performance is evaluated with the use of benchmarks. Benchmarks are essentially tests that mimic many of the standard school tests humans are given in primary school. For example, we might ask the model to perform tasks such as answering multiple choice questions, asking it to complete a sentence, reading comprehension or solve a true or false question. And just like human tests the models are graded with an accuracy number calculated as the number of correct answers divided by total number of questions asked. In this way AI models like Llama-3.1-8B-Instruct are evaluated.

Referring back to quantization. In the world of artificial intelligence a model quantization strategy is highly suspect until you can prove that it works in practice. A quantization strategy is effective if a model can be quantized and retain similar scores on various benchmarks and compared to its original state. For example if Llama-3.1-8B-Instruct scores 83% on benchmark X and after its been quantized it only scores 20% then the quantization strategy is not good enough for real world applications. These kinds of regressions after quantization happen often and are hard to predict until one does the experiment.

Thus in order to show evidence that algebraic integer encodings can be applied to the field of artificial intelligence the following experiment was performed. An already trained Llama-3.1-8B-Instruct model was used and all of its linear layer weights were quantized using an MX4 quantization strategy. The linear weights were also quantized using the Algebraic Integer Format quantization representation of a−b*√(2), wherein (a=b=2 bit). After quantization, the benchmarks winogrande, piqa, boolq and lambada_openai were run and an average accuracy score was taken across them. The results are as follows:

| Baseline BF16 accuracy | QINT4 accuracy | MX4_E2M1 accuracy |
|---|---|---|
| average | average | average |
| 79.11% | 77.32% | 76.60% |

Baseline—The original bf16 model performance

QINT4-A weight only quantization of all Llama-3.1-8B-Instruct linear layers using the representation a−b*√(2) (a−b=2 bit). Using a 32 value blocksize, min_max scaling strategy and a block scale factor type bf16.

MX4_E2M1—This mx4 type is as described in the OCP specification

As you can see the QINT4 type is achieving a 0.72% increase in accuracy versus the established MX4 type.

### Referring to the FIGS.:

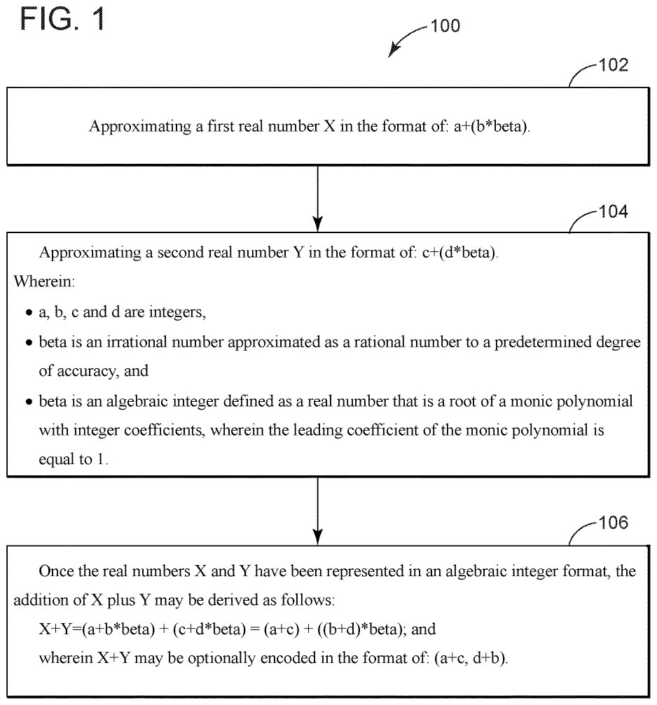

Referring to FIG. 1, an example is depicted of a computer-implemented method 100 of addition of real numbers represented in an algebraic integer format, according to aspects described herein.

The method may be implemented in a computer system, which includes a memory and one or more processors in electronic communication with the memory. An algorithm may be stored in the memory as a set of instructions for execution by the one or more processors. The algorithm may be programmed to perform the method.

The method may also be stored in a computer program product. The computer program product may include at least one non-transitory computer readable storage medium. The storage medium may store instructions, for execution by a processor, to perform the method.

The method begins at 102, by approximating a first real number X in the format of: a+(b*β).

At 104 a second real number Y is approximated in the format of: c+(d*β). Wherein:
i.a, b, c and d are integers,
ii.β is an irrational number approximated as a rational number to a predetermined degree of accuracy, and
iii.β is an algebraic integer defined as a real number that is a root of a monic polynomial with integer coefficients, wherein the leading coefficient of the monic polynomial is equal to 1.

More specifically, at 102 and 104, β may be an algebraic integer of degree two, wherein β is the root of a monic polynomial of the form (β²)−(p*β)−q=0, and wherein p and q are also integers.

The predetermined degree of accuracy may be within 4 bits of precision, 8 bits of precision, 12 bits of precision or more. For example, β may be equal to the square root of 2 (i.e., 2^{0.5}, or √(2). Additionally, p may be equal to 0, q may be equal to 2; and the monic polynomial may be β²−2=0. If the irrational number of 2^{0.5} is estimated to be the rational number of 181/128, then β is estimated within an precision accuracy of at least 12 bits.

Note also that there may be any number of other values other than 2^{0.5} for β and there may be any number of monic polynomials of which β is a root of that can be used for steps 102 and 104. For example, β may equal (1−5^{0.5})/2 or (1+5^{0.5})/2, wherein the monic polynomial is β²−β−1=0, wherein p equals 1 and q equals 1.

At 106, once the real numbers X and Y have been represented in an algebraic integer format, the addition of X plus Y may be derived as follows:
1. X+Y=(a+b*β)+(c+d*β)=(a+c)+((b+d)*β); and
2. wherein X+Y may be optionally encoded in the format of: (a+c, d+b).

Additionally, the sign or X and Y may also be determined using the following algorithm:
1. sign of X is +1 if a+b*β is greater than 0, otherwise sign of X is −1; and
2. sign of Y is +1 if c+d*β is greater than 0, otherwise sign of Y is −1.

More generally, the sign of any real number Z represented in the algebraic integer format of a+b*β can be determined using the above algorithm.

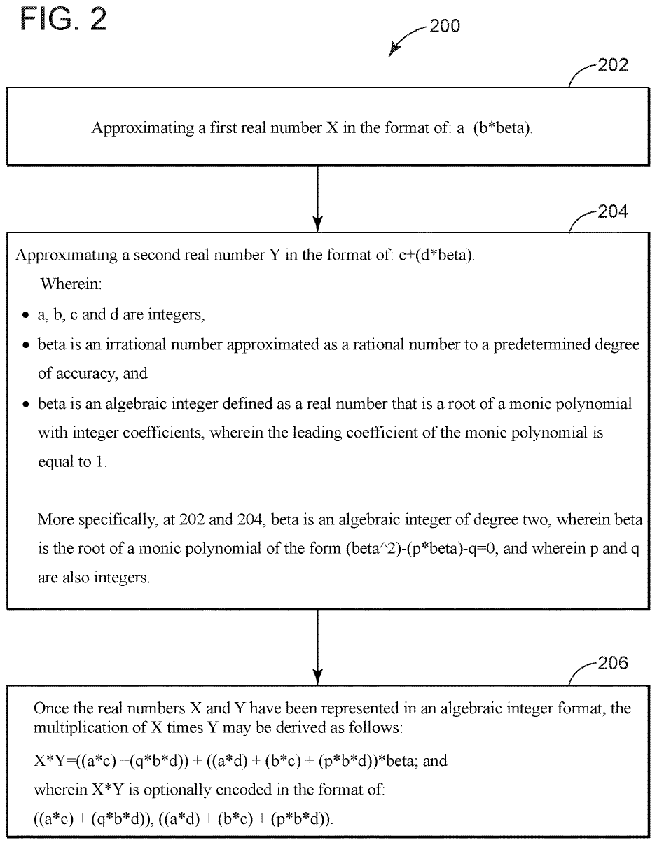

Referring to FIG. 2, an example is depicted of a computer-implemented method 200 of multiplication of real numbers represented in an algebraic integer format, according to aspects described herein.

The method 200 is similar to method 100, wherein the method 200 begins at 202 by approximating a first real number X in the format of: a+(b*β).

At 204 a second real number Y is approximated in the format of: c+(d*β). Wherein:
i.a, b, c and d are integers,
ii.β is an irrational number approximated as a rational number to a predetermined degree of accuracy, and
iii.β is an algebraic integer defined as a real number that is a root of a monic polynomial with integer coefficients, wherein the leading coefficient of the monic polynomial is equal to 1.

Also more specifically, at 202 and 204, β may be an algebraic integer of degree two, wherein β is the root of a monic polynomial of the form (β²)−(p*)−q=0, and wherein p and q are also integers.

At 206, once the real numbers X and Y have been represented in an algebraic integer format, the addition of X plus Y may be derived as follows:
1. X*Y=((a*c)+(q*b*d))+((a*d)+(b*c)+(p*b*d))*β; and
2. wherein X*Y is optionally encoded in the format of: ((a*c)+(q*b*d)), ((a*d)+(b*c)+(p*b*d)).

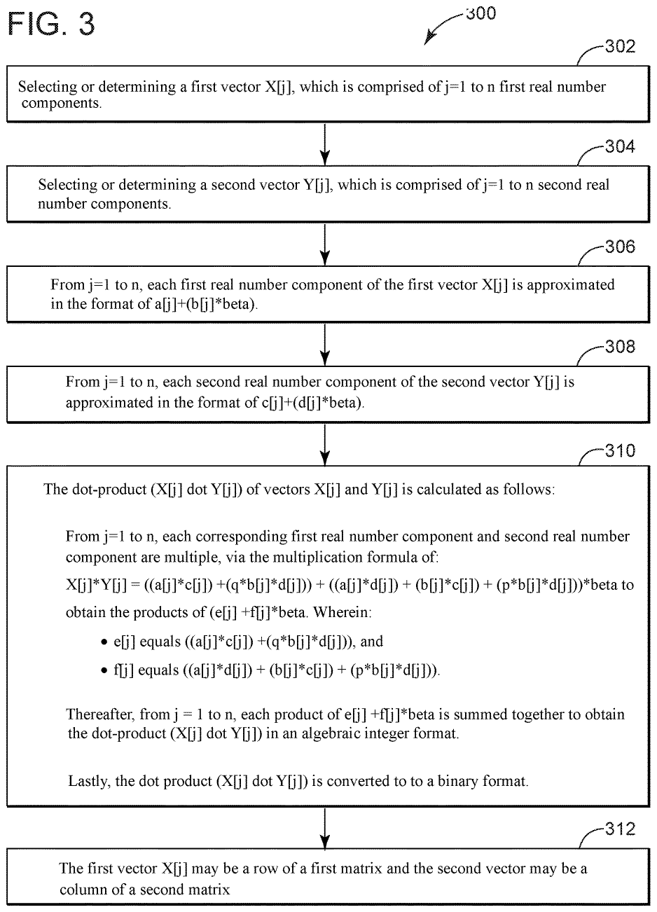

Referring to FIG. 3, an example is depicted of a computer-implemented method 300 of calculating a dot-product of two vectors represented in an algebraic integer format, according to aspects described herein.

The method 300 begins at 302 by selecting or determining a first vector X[j], which is comprised of j=1 to n first real number components.

At 304, a second vector Y[j] is selected or determined, which is comprised of j=1 to n second real number components.

At 306, from j=1 to n, each first real number component of the first vector X[j] is approximated in the format of a[j]+(b[j] *β).

At 308, from j=1 to n, each second real number component of the second vector Y[j] is approximated in the format of c[j]+(d[j] *β).

At 310, the dot-product (X[j] dot Y[j]) of vectors X[j] and Y[j] is calculated as follows:

From j=1 to n, each corresponding first real number component and second real number component are multiple, via the multiplication formula of:
X[j] *Y[j]=((a[j] *c[j])+(q*b[j] *d[j]))+((a[j] *d[j])+(b[j] *c[j])+(p*b[j] *d[j]))*β to obtain the products of (e[j]+f[j] *β. Wherein:
e[j] equals ((a[j] *c[j])+(q*b[j] *d[j])), and
f[j] equals ((a[j] *d[j])+(b[j] *c[j])+(p*b[j] *d[j])).

Thereafter, from j=1 to n, each product of e[j]+f[j] *β is summed together to obtain the dot-product (X[j] dot Y[j]) in an algebraic integer format.

Lastly, the dot product (X[j] dot Y[j]) is converted to a binary format.

At 312, the first vector X[j] may be a row of a first matrix and the second vector may be a column of a second matrix.

Accordingly, a first and a second matrix may be multiplied together row by column, wherein there are j=1 to n number of real number components in each row of the first matrix, and j=1 to n number of real number components in each column of the second matrix.

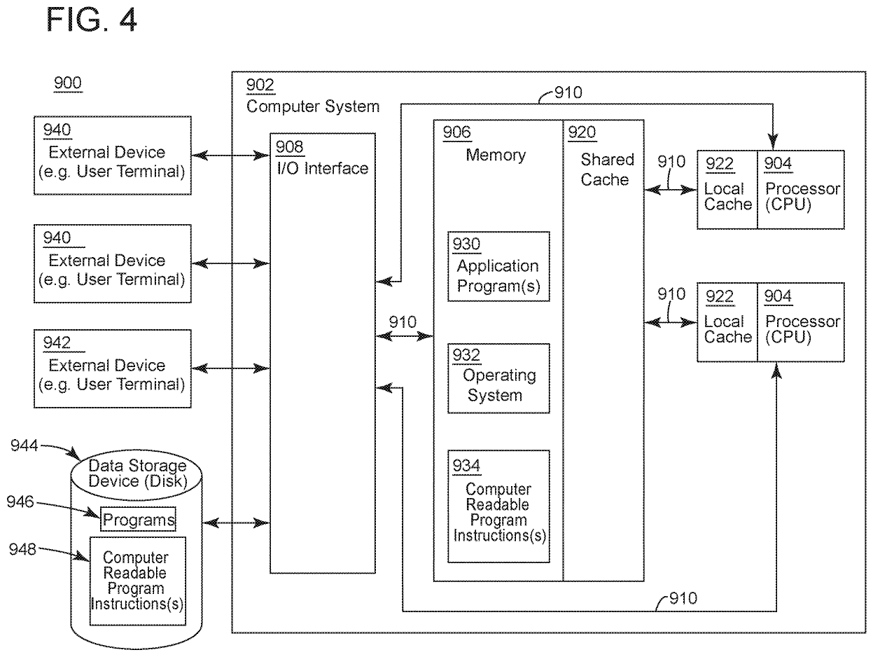

Referring to FIG. 4, an example is depicted of a computing environment 900 useable to perform the methods 100 of FIG. 1, 200 of FIGS. 2 and 300 of FIG. 3, according to aspects described herein. The computing environment includes, for instance, a computer system 902 shown, e.g., in the form of a general-purpose computing device. Computer system 902 may include, but is not limited to, one or more processors or processing units 904 (e.g., central processing units (CPUs)), a memory 906 (a.k.a., system memory, main memory, main storage, central storage or storage, as examples), and one or more input/output (I/O) interfaces 908, coupled to one another via one or more buses and/or other connections 910.

Bus 910 represents one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and the Peripheral Component Interconnect (PCI).

Memory 906 may include, for instance, a cache 920, such as a shared cache, which may be coupled to local caches 922 of processors 904. Further, memory 906 may include one or more programs or applications 930, an operating system 932, and one or more computer readable program instructions 934. Computer readable program instructions 934 may be configured to carry out functions of embodiments of aspects of the invention.

Computer system 902 may also communicate via, e.g., I/O interfaces 908 with one or more external devices 940, one or more network interfaces 942, and/or one or more data storage devices 944. Example external devices include a user terminal, a tape drive, a pointing device, a display, etc. Network interface 942 enables computer system 902 to communicate with one or more networks, such as a local area network (LAN), a general wide area network (WAN), and/or a public network (e.g., the Internet), providing communication with other computer devices or systems. For example, the system may be connected to a personal computer, tablet device or smart phone to communicate the assigned or unassigned status of mobile objects to user via a graphical user interface.

Data storage device 944 may store one or more programs 946, one or more computer readable program instructions 948, and/or data, etc. The computer readable program instructions may be configured to carry out functions of embodiments of aspects of the invention.

Computer system 902 may include and/or be coupled to removable/non-removable, volatile/non-volatile computer system storage media. For example, it may include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media. It should be understood that other hardware and/or software components could be used in conjunction with computer system 902. Examples, include, but are not limited to: microcode, device drivers, redundant processing units, external disk drive arrays, RAID systems, tape drives, and data archival storage systems, etc.

Computer system 902 may be operational with numerous other general purposes or special purpose computing system environments or configurations. Examples of well-known computing systems, environments, and/or configurations that may be suitable for use with computer system 902 include, but are not limited to, personal computer (PC) systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

One or more of the processors and/or other aspects of the computer system or computing environment may be remote from the mobile object. Further, in one particular example, a processor, such as processor 904, may execute, in accordance with one or more aspects of the present invention, one or more machine learning engines and/or other engines to provide, based on training and learning, an optimal travel route or path for mobile object. These engines may be stored in memory, including main memory and/or one or more caches, and/or external storage, and may be executed on one or more processors. Many variations exist.

One or more aspects of the present invention are inextricably tied to computer technology and/or to the improvement of a technical field.

One or more aspects may relate to cloud computing. It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

Aspects of the present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages such as Angular, HTML, CSS, .NET Framework, C# and Microsoft SQL Server, and including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, different types of unmanned aerial vehicles may be used, as well as other types of neural networks and/or evolutionary algorithms. Many variations are possible.

Further, other types of computing environments can benefit and be used. As an example, a data processing system suitable for storing and/or executing program code is usable that includes at least two processors coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

It should be appreciated that all combinations of the foregoing concepts and additional concepts discussed in greater detail herein (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

Although the invention has been described by reference to specific examples, it should be understood that numerous changes may be made within the spirit and scope of the inventive concepts described. Accordingly, it is intended that the disclosure not be limited to the described examples, but that it has the full scope defined by the language of the following claims.

What is claimed is:

1. A computer implemented method of arithmetic operations of real numbers represented in an algebraic integer format, comprising:
approximating a first real number X in the format of: a+(b*):
approximating a second real number Y in the format of: c+(d*β); and
wherein:
a, b, c and d are integers,
β is an irrational number approximated as a rational number to a predetermined degree of accuracy, and
β is an algebraic integer defined as a real number that is a root of a monic polynomial with integer coefficients, wherein the leading coefficient of the monic polynomial is equal to 1.

2. The computer implemented method of claim 1, wherein:
β is an algebraic integer of degree two, wherein β is the root of a monic polynomial of the form (β²)−(p*β)−q=0, and wherein p and q are integers.

3. The computer implemented method of claim 1 wherein the predetermined degree of accuracy is within 4 bits of precision or more.

4. The computer implemented method of claim 1 wherein the predetermined degree of accuracy is within 8 bits of precision or more.

5. The computer implemented method of claim 2, wherein algebraic integer addition of X plus Y is derived as follows:
X+Y=(a+b*β)+(c+d*β)=(a+c)+((b+d)*β); and
wherein X+Y may be optionally encoded in the format of: (a+c, d+b).

6. The computer implemented method of claim 5, wherein the algebraic integer multiplication of X time Y is derived as follows:
X*Y=((a*c)+(q*b*d))+((a*d)+(b*c)+(p*b*d))*β; and
wherein X*Y is optionally encoded in the format of:
((a*c)+(q*b*d)),((a*d)+(b*c)+(p*b*d)).

7. The computer implemented method of claim 2, wherein:
β equal 2^{0.5};
p equals 0;
q equals 2; and
the monic polynomial is: β²−2=0

8. The computer implemented method of claim 7, wherein β is approximated to be the rational number of 181/128.

9. The computer implemented method of claim 2, wherein:
β equals (1−5^{0.5})/2;
p equals 1;
q equals 1; and
the monic polynomial is β²−β−1=0

10. The computer implemented method of claim 2, wherein:
sign of X is +1 if a+b*β is greater than 0, otherwise sign of X is −1; and
sign of Y is +1 if c+d*β is greater than 0, otherwise sign of Y is −1.

11. The computer implemented method of claim 6, comprising:
the first real number X is a first real number component of a first vector X[j] comprised of j=1 to n first real number components;
the second real number Y is a second real number component of a second vector X[j] comprised of j=1 to n second real number components;
approximating, from j=1 to n, each first real number component of the first vector X[j] in the format of a[j]+(b[j] *β);
approximating, from j=1 to n, each second real number component of the second vector Y[j] in the format of c[j]+(d[j] *β); and
calculating a dot product (X[j] dot Y[j]) of the vectors X[j] and Y[j] as follows:
multiplying, from j=1 to n, each corresponding first real number component and second real number component via the multiplication formula of:
X[j] *Y[j]=((a[j] *c[j])+(q*b[j] *d[j]))+((a[j] *d[j])+(b[j] *c[j])+(p*b[j] *d[j]))*B to obtain the products of (e[j]+f[j] *β, wherein:
e[j] equals ((a[j] *c[j])+(q*b[j] *d[j])), and
f[j] equals ((a[j] *d[j])+(b[j] *c[j])+(p*b[j] *d[j])),
summing, from j=1 to n, each product of e[j]+f[j] *β to obtain the dot product (X[j] dot Y[j]) in an algebraic integer format, and
converting the dot product (X[j] dot Y[j]) to a binary format.

12. The computer implemented method of claim 11, wherein:
first vector X[j] is a row of a first matrix; and
second vector Y[j] is a column of a second matrix.

13. A computer implemented method of arithmetic operations of real numbers represented in an algebraic integer format, comprising:
approximating a first real number X in the format of: a+(b*β):
approximating a second real number Y in the format of: c+(d*β); and
wherein:
a, b, c and d are integers,
β is an irrational number approximated as a rational number to a predetermined degree of accuracy of 4 bits or greater, and
β is an algebraic integer of degree two defined as a real number that is a root of a monic polynomial of the form (β²)−(p*β)−q=0, and wherein p and q are integers.

14. The computer implemented method of claim 13 wherein the predetermined degree of accuracy is within 8 bits of precision or more.

15. The computer implemented method of claim 13, wherein algebraic integer addition of X plus Y is derived as follows:
X+Y=(a+b*β)+(c+d*β)=(a+c)+((b+d)*β); and
wherein X+Y may be optionally encoded in the format of: (a+c, d+b).

16. The computer implemented method of claim 13, wherein the algebraic integer multiplication of X time Y is derived as follows:
X*Y=((a*c)+(q*b*d))+((a*d)+(b*c)+(p*b*d))*β; and
wherein X*Y is optionally encoded in the format of:
((a*c)+(q*b*d)),((a*d)+(b*c)+(p*b*d)).

17. The computer implemented method of claim 13, wherein:
β equal 2^{0.5;}
p equals 0;
q equals 2; and
the monic polynomial is: β²−2=0

18. The computer implemented method of claim 13, wherein:
sign of X is +1 if a+b*B is greater than 0, otherwise sign of X is −1; and
sign of Y is +1 if c+d*β is greater than 0, otherwise sign of Y is −1.

19. The computer implemented method of claim 13, wherein:
sign of X is +1 if a+b*β is greater than 0, otherwise sign of X is −1; and
sign of Y is +1 if c+d*β is greater than 0, otherwise sign of Y is −1.

20. The computer implemented method of claim 16, comprising:
the first real number X is a first real number component of a first vector X[j] comprised of j=1 to n first real number components;
the second real number Y is a second real number component of a second vector X[j] comprised of j=1 to n second real number components;
approximating, from j=1 to n, each first real number component of the first vector X[j] in the format of a[j]+(b[j] *β);
approximating, from j=1 to n, each second real number component of the second vector Y[j] in the format of c[j]+(d[j] *β); and
calculating a dot product (X[j] dot Y[j]) of the vectors X[j] and Y[j] as follows:
multiplying, from j=1 to n, each corresponding first real number component and second real number component via the multiplication formula of:
X[j] *Y[j]=((a[j] *c[j])+(q*b[j] *d[j]))+((a[j] *d[j])+(b[j] *c[j])+(p*b[j] *d[j]))*β to obtain the products of (e[j]+f[j] *β, wherein:
e[j] equals ((a[j] *c[j])+(q*b[j] *d[j])), and
f[j] equals ((a[j] *d[j])+(b[j] *c[j])+(p*b[j] *d[j])),
summing, from j=1 to n, each product of e[j]+f[j] *β to obtain the dot product (X[j] dot Y[j]) in an algebraic integer format, and
converting the dot product (X[j] dot Y[j]) to a binary format.
